(19) United States
(12) Patent Application Publication
(10) Pub. No.: US 2026/0071895 A1
(43) Pub. Date: Mar. 12, 2026

(54) METAL DETECTOR

(71) Applicant: ANRITSU CORPORATION, Kanagawa (JP)

(72) Inventors: Yuki HAYAKAWA, Kanagawa (JP); Yasuhito KAJIWARA, Kanagawa (JP)

(21) Appl. No.: 19/320,066

(22) Filed: Sep. 5, 2025

(30) Foreign Application Priority Data
Sep. 11, 2024 (JP) 2024-157747

(51) Int. Cl. G01D 5/22

(52) U.S. Cl. CPC G01D 5/2225

(57) ABSTRACT

In a metal detector, a magnetic field output unit generates an alternating magnetic field, a magnetic field detection unit detects a change in magnetic field caused by an inspection object passing through the alternating magnetic field to output a detection signal, and a control unit detects whether or not metal foreign matter is contained in the inspection object based on the detection signal. A storage unit sequentially stores influence value information including phase information, amplitude information, or a Lissajous waveform obtained based on the detection signal when an accepted product that is determined not to contain metal foreign matter passes through the alternating magnetic field. When the influence value information is changed to exceed a predetermined criterion, the control unit determines that a state of the inspection object is changed, and a notification unit notifies the determination.

### TECHNICAL FIELD

The present invention relates to a metal detector.

### BACKGROUND ART

In a production line of food or the like, a metal detector is used to inspect whether or not metal is contained in an inspection object on a line. In addition, the metal detector uses a masterwork as a reference material of an inspection object and has an automatic setting function of determining an internal parameter to minimize a change in magnetic field caused by influence of the masterwork (Patent Document 1). In addition, it is known that a reference Lissajous waveform is generated from a detection signal obtained using a masterwork as a reference material of an inspection object and a determination line is set to determine whether or not foreign matter is contained (Patent Document 2). With this technique, metal in an inspection object can be accurately detected while simply executing a setting operation.

However, when a state of an inspection object changes over time as compared to that at the time of the determination of the internal parameter, for example, when frozen food that is the inspection object melts or the amount of water in the inspection object changes, a change in magnetic field caused when a non-defective product of the inspection object passes may vary. In this case, a change in magnetic field largely appears in the inspection object originally not containing metal foreign matter, which may lead to erroneous determination that metal foreign matter is contained therein.

This state change of the inspection object is not a clear change in appearance that can be seen. In the related art, when erroneous detection occurs in the metal detector, for example, determination that metal foreign matter is contained is made frequently within a short period of time, and it is found afterwards that this detection is caused by the occurrence of the state change of the inspection object after verifying that the inspection object is originally a non-defective product. Therefore, a period of time is required to verify the occurrence of the state change of the inspection object, and there is a concern that a non-defective product may be disposed during the time, which leads to a problem of a decrease in productivity or disposal loss.

### [Related art Document]

### [Patent Document]

[Patent Document 1] Japanese Patent No. 4188283

[Patent Document 2] WO2015/49766

### DISCLOSURE OF THE INVENTION

### Problem that the Invention is to Solve

The present invention has been made in consideration of the above-described circumstances, and an object thereof is to provide a metal detector that facilitates improvement of productivity and a decrease in disposal loss.

### Means for solving the problem

In order to achieve the above-described object, according to a first aspect of the present invention, there is provided a metal detector including: a magnetic field output unit configured to generate an alternating magnetic field in a transport path of an inspection object; a magnetic field detection unit configured to detect a change in magnetic field caused by the inspection object passing through the alternating magnetic field to output a detection signal; a metal determination unit configured to determine whether or not metal is contained in the inspection object based on the detection signal; a storage unit configured to sequentially store, as influence value information, information including phase information and amplitude information that is obtained based on the detection signal when an accepted product passes through the alternating magnetic field, the accepted product being the inspection object that is determined not to contain metal by the metal determination unit; a state change determination unit configured to determine whether or not a state of the inspection object is changed based on whether or not the influence value information exceeds a predetermined criterion; and a notification unit configured to notify, when the state change determination unit determines that the state of the inspection object is changed, the determination.

In addition, according to a second aspect of the present invention, in the metal detector according to the first aspect, the storage unit stores predetermined plural types of the influence value information, and when all of the plural types of the influence value information exceed the predetermined criterion, the state change determination unit determines that the state of the inspection object is changed.

In addition, according to a third aspect of the present invention, in the metal detector according to the first aspect, the storage unit stores a Lissajous waveform including the phase information and the amplitude information as the influence value information.

In addition, according to a fourth aspect of the present invention, in the metal detector according to the third aspect, when limit lines are set as the predetermined criterion on coordinates of the Lissajous waveform and the Lissajous waveform and any one of the limit lines intersect with each other, the state change determination unit determines that the state of the inspection object is changed.

In the metal detector according to the first aspect of the present invention, a state change of an inspection object can be grasped before erroneously determining a non-defective product (acceptable product) as a defective product (product to be rejected), and operating conditions or the temperature management of the inspection object in a production line can be re-examined, or the setting process of the metal detector can be executed again. As a result, improvement of productivity and a decrease in disposal loss can be facilitated.

In addition, in the metal detector according to the second aspect of the present invention, even when one of the plurality of influence value information is changed instead of the state change of the inspection object, the state change of the inspection object can be more accurately determined without being excessively determined.

In addition, in the metal detector according to the third aspect of the present invention, it can be more accurately determined using the Lissajous waveform that the state of the inspection object is changed based on the phase information and the amplitude information.

In addition, in the metal detector according to the fourth aspect of the present invention, the predetermined criterion for determining the state change of the inspection object can be simply set on the coordinate axis of the Lissajous waveform.

### Advantage of the Invention

The metal detector according to the present invention exhibits the effect of facilitating improvement of productivity and a decrease in disposal loss.

The present invention has been briefly described above. Further, the details of the present invention will be further clarified by reading through a mode for carrying out the invention described below (hereinafter referred to as an "embodiment") with reference to the accompanying drawings.

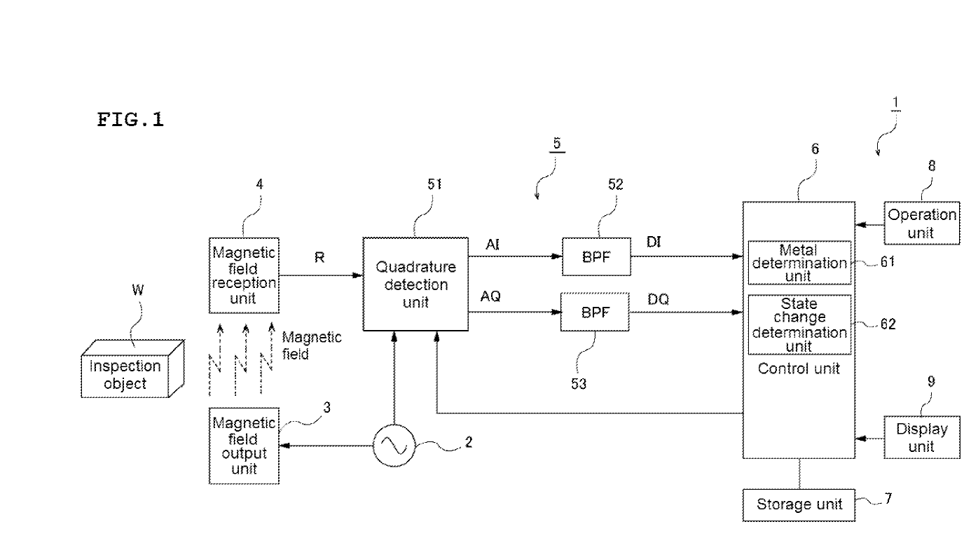

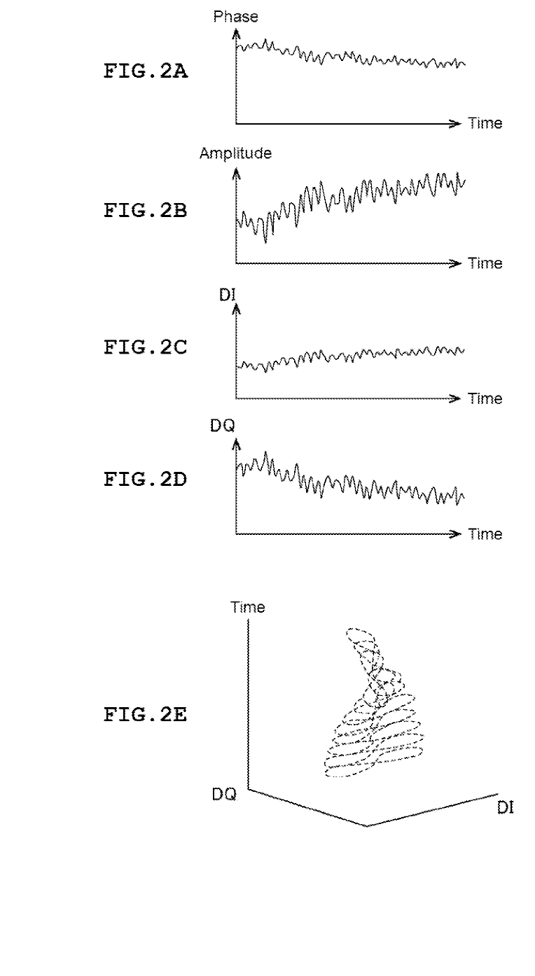

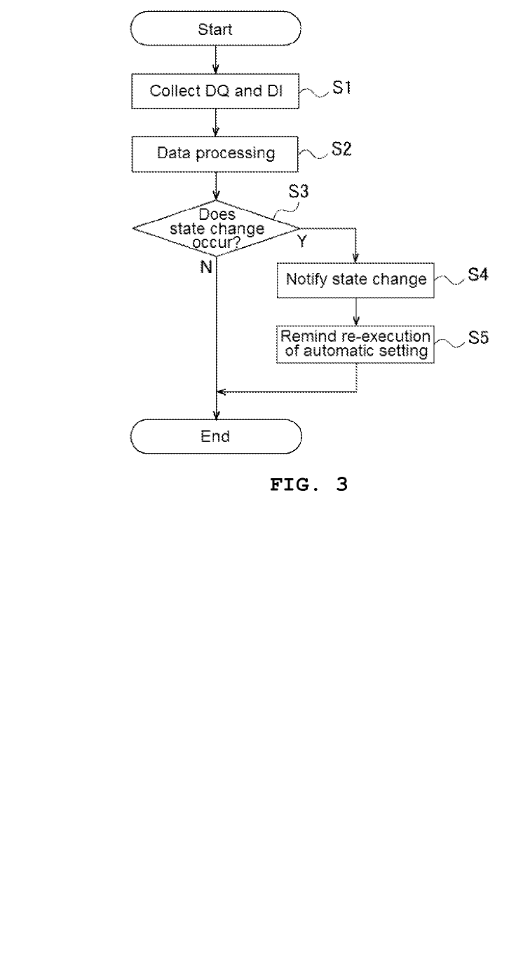

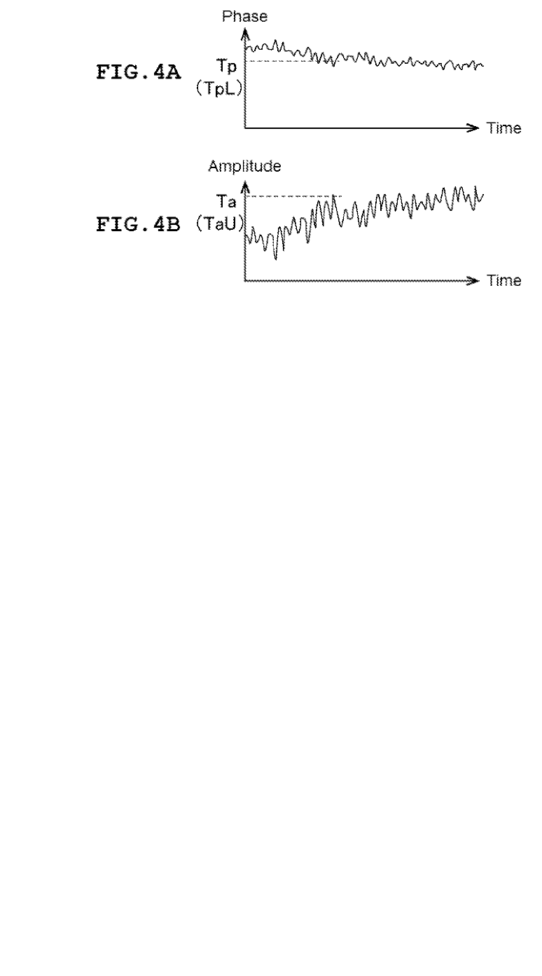

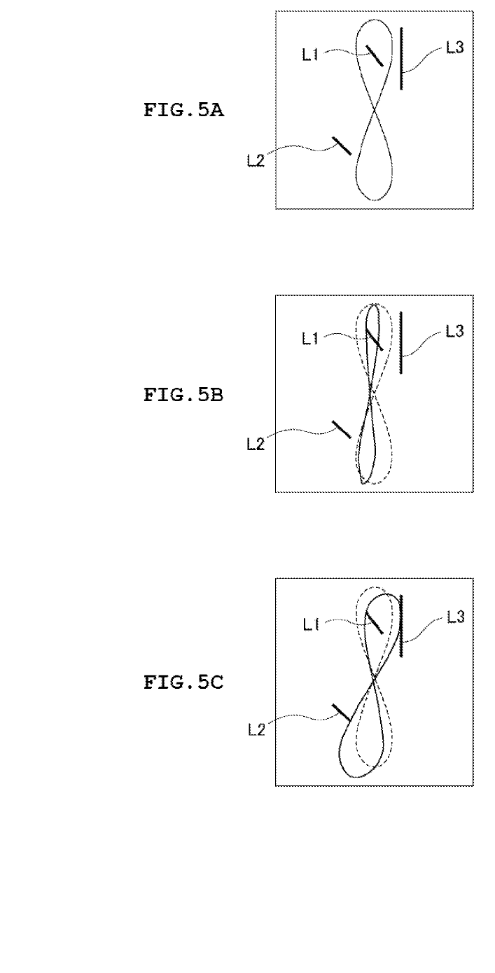

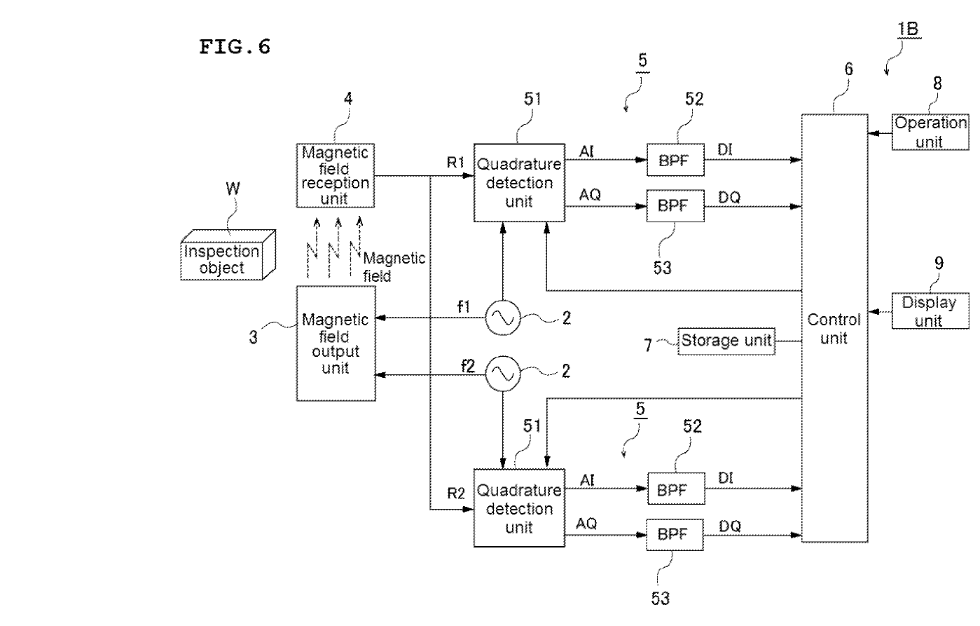

### BRIEF DESCRIPTION OF THE DRAWINGS

[FIG. 1] FIG. 1 is a block diagram illustrating an embodiment of a metal detector according to the present invention.

[FIGS. 2A to 2E] FIGS. 2A to 2E are graphs illustrating chronological transitions of a phase, an amplitude, detection signals DI and DQ, and a Lissajous waveform of a reception signal R illustrated in FIG. 1.

[FIG. 3] FIG. 3 is a flowchart illustrating a procedure of a state change detection process that is executed by a control unit configuring a metal detector illustrated in FIG. 1.

[FIGS. 4A and 4B] FIGS. 4A and 4B are diagrams illustrating a state change determination process that is executed in S3 of FIG. 3.

[FIGS. 5A to 5C] FIGS. 5A to 5C are diagrams illustrating a criterion of the state change determination process using a Lissajous waveform that is executed in S3 of FIG. 3.

[FIG. 6] FIG. 6 is a block diagram illustrating another embodiment of the detector according to the present invention.

### BEST MODE FOR CARRYING OUT THE INVENTION

Specific embodiments of the present invention will be described below with reference to the respective drawings.

A metal detector 1 illustrated in FIG. 1 detects metal foreign matter contained in an inspection object W. As illustrated in FIG. 1, the metal detector 1 includes a signal generator 2, a magnetic field output unit 3, a magnetic field reception unit 4, a detection unit 5, a control unit 6, a storage unit 7, an operation unit 8, and a display unit 9.

The signal generator 2 outputs a signal having a predetermined frequency. The magnetic field output unit 3 receives a signal from the signal generator 2, and generates an alternating magnetic field having a predetermined frequency in a transport path where the inspection object W is transported. The magnetic field reception unit 4 outputs a reception signal R corresponding to a change in magnetic field caused by an object passing through the alternating magnetic field. The magnetic field reception unit 4 includes two reception coils (not illustrated) that receive the alternating magnetic field generated from the magnetic field output unit 3.

The two reception coils are arranged along a transport direction of the inspection object W at positions where the same alternating magnetic fields are received in the same amount. In addition, the two reception coils are differentially connected. Therefore, when the inspection object W or the metal foreign matter does not have influence on the alternating magnetic field, amplitudes of signals induced from the two reception coils are the same, and the phase is reversed. Therefore, the amplitude of the reception signal R is zero.

In the present embodiment, the case where the two reception coils are differentially connected will be described. The magnetic field reception unit 4 may be configured to allow an analog subtractor to subtract the signals induced from the two reception coils from each other. In addition, when the magnetic fields received by the two reception coils are not the same amount, a difference between the signals induced from the two reception coils may be corrected by a variable resistor or an amplifier having different amplification degrees.

The control unit 6 is configured with a microcomputer including a CPU, a RAM, and a ROM, and causes the CPU to execute a control program stored in the ROM while transmitting and receiving data to and from the RAM. The control unit 6 includes a functional block as a metal determination unit 61, imports the detection signals DI and DQ at a timing at which the inspection object W enters into the transport path, and the imported signal and a preset determination value are compared to each other, for example, to determine whether or not metal foreign matter is contained in the inspection object W. In addition, the control unit 6 causes the display unit 9 to display a determination result (for example, OK or NG) of the metal determination unit 61 regarding whether or not metal foreign matter is contained in the inspection object W.

The control unit 6 is configured with a microcomputer including a CPU, a RAM, and a ROM, and causes the CPU to execute a control program stored in the ROM while transmitting and receiving data to and from the RAM. The control unit 6 functions as a metal foreign matter detection unit, imports the detection signals DI and DQ at a timing at which the inspection object W enters into the transport path, and the imported signal and a preset determination value are compared to each other to determine whether or not metal foreign matter is contained in the inspection object W. In addition, when it is determined that metal foreign matter is contained in the inspection object W, the control unit 6 causes the display unit 9 to display the determination.

The control unit 6 is connected to the operation unit 8 and the display unit 9 and, when a setting mode is designated by the operation unit 8, executes a process of setting various parameters. When an inspection mode is designated by the operation unit 8, the control unit 6 causes the metal detection unit 61 to execute a process of inspecting whether or not metal foreign matter is contained in the inspection object W, and causes the display unit 9 to execute a process of displaying the inspection result.

Inspection parameters required for inspecting whether or not metal foreign matter is contained include a length and a transport speed of the inspection object W, a frequency of a signal generated from the alternating magnetic field, a detection phase of a reference signal (phase shift amount of the reference signal relative to the signal output from the signal generator 2), and a determination threshold for determining whether or not metal foreign matter is contained.

The control unit 6 executes an automatic setting process for setting inspection parameters required for inspecting whether or not metal foreign matter is contained for each type of the inspection object W.

When the execution of the automatic setting process is instructed by the operation unit 8, the control unit 6 shifts the metal detector 1 from the inspection mode to the setting mode to start the automatic setting process, determines a phase of a reference signal output from a quadrature detection unit 51 based on phases and amplitudes of the detection signals DI and DQ when a non-defective product (also referred to as an acceptable product) of the inspection object W passes through the alternating magnetic field, determines a determination threshold for determining whether or not metal foreign matter is contained, and causes the storage unit 7 to store the determination threshold in association with the type of the inspection object W, and returns to the inspection mode.

The storage unit 7 sequentially stores influence value information including phase information and amplitude information of the reception signal R when a non-defective product passes through the alternating magnetic field, the non-defective product being the inspection object W not containing metal foreign matter. The influence value information is information that changes due to influence of a state change of the inspection object W. In the present embodiment, the storage unit 7 sequentially stores, as the influence value information, a phase that is the phase information, an amplitude (refer to FIGS. 2A and 2B) that is the amplitude information, or a Lissajous waveform (refer to FIG. 2E).

The phase and the amplitude described above can be obtained from the detection signals DI and DQ. In addition, the Lissajous waveform is a waveform obtained by plotting the detection signals DQ and DI (refer to FIGS. 2C and 2D) as a data pair in a chronological manner on a graph where the vertical axis represents the detection signal DQ and the horizontal axis represents the detection signal DI, the detection signals DQ and DI being sampled while a non-defective product is passing through the alternating magnetic field. Therefore, it can be said that the Lissajous waveform is the information including the phase information and the amplitude information.

The Lissajous waveform is, for example, a substantially figure eight shape as illustrated in FIG. 2E, and may have a shape that varies depending on the type of the inspection object W. The storage unit 7 sequentially stores a plurality of Lissajous waveforms obtained whenever a non-defective product of the inspection object W passes through the alternating magnetic field.

In addition, the control unit 6 includes a functional block as a state change determination unit 62 that executes a state change determination process of determining a state change of the inspection object W during the inspection process. This state change determination process will be described below with reference to a flowchart of FIG. 3.

First, while one inspection object W passes through the alternating magnetic field and the detection signals DI and DQ output by synchronous detection of the reception signal R are input, the control unit 6 samples the detection signals DI and DQ at a predetermined time interval, and causes the storage unit 7 to store at least sampling data obtained while the inspection object W is passing through the alternating magnetic field (S1). Next, the control unit 6 reads the sampling data regarding the inspection object W from the storage unit 7 at a timing where the inspection object W passes, and processes the signal. That is, the control unit 6 processes a plurality of detection signals DI and DQ to obtain a phase, an amplitude, or a Lissajous waveform of the reception signal R, and causes the storage unit 7 to store the phase, the amplitude, or the Lissajous waveform obtained as detection data (S2).

In S2, the control unit 6 does not need to cause the storage unit 7 to store a phase, an amplitude, or a Lissajous waveform of the reception signal R obtained as detection data when a defective product of the inspection object W containing metal foreign matter passes. As a result, the control unit 6 causes the storage unit 7 to sequentially store the phase, the amplitude, or the Lissajous waveform of the reception signal R when the non-defective product of the inspection object W passes through the alternating magnetic field.

Next, the state change determination unit 62 of the control unit 6 reads the phase, the amplitude, or the Lissajous waveform of the reception signal R from the storage unit 7, and determines whether or not there is a change in phase or amplitude immediately after executing the automatic setting process based on whether or not a predetermined criterion is exceeded (S3). When it is determined that the predetermined criterion is exceeded (Y in S3), the control unit 6 causes display means 91 as a notification unit 9 (S4) to notify that the state of the inspection object W is changed. In addition, the control unit 6 causes the display means 91 to remind that the state of the inspection object W is determined to be changed and the automatic setting process is executed again (S5), and ends the process. When it is determined that the phase, the amplitude, or the Lissajous waveform does not exceed the predetermined criterion (N in S3), the control unit 6 ends the state change determination process of the state change determination unit 62 for the inspection object W. The term “exceeding the criterion” refers to displacement from one side to the other side with respect to the criterion as a boundary.

Next, the detection of S3 will be described in detail.

First, the state change determination process using the phase or the amplitude will be described. As illustrated in FIGS. 4A and 4B, when the phase or the amplitude of the reception signal R transitioning in a chronological order crosses a predetermined threshold Tp or Ta as the predetermined criterion, the state change determination unit 62 of the control unit 6 determines that the state of the inspection object W is changed. The threshold Tp or Ta may be determined based on the value of the phase or the amplitude of the reception signal R immediately after the automatic setting process.

For example, FIGS. 4A and 4B illustrate chronological transitions of the phase and the amplitude when the inspection object W of one type sequentially passes through the metal detector 1, and are graphs illustrating an example of a tendency where the phase gradually decreases while being increased and decreased and a tendency where the amplitude gradually increases while being increased and decreased. The threshold Tp or Ta indicated by a dotted line in each of the graphs is the predetermined criterion for determining whether or not the state of the inspection object W is changed based on the chronological transitions of the phase and the amplitude.

As illustrated in FIG. 4A, in the case of this type of the inspection object W, a lower limit value TpL as the threshold Tp is set to a value lower than the phase immediately after the automatic setting process through an operation input of the operation unit 8. The state change determination unit 62 of the control unit 6 sets a phase change flag to ON when a phase of one inspection object W falls below the lower limit value TpL, and subsequently sets the phase change flag to OFF when a phase of another inspection object W exceeds the lower limit value TpL.

As illustrated in FIG. 4B, in the case of this type of the inspection object W, an upper limit value TaU as the threshold Ta is set to a value higher than the amplitude immediately after the automatic setting process through an operation input of the operation unit 8. The state change determination unit 62 of the control unit 6 sets an amplitude change flag to ON when a phase of one inspection object W exceeds the upper limit value TaU, and subsequently sets the amplitude change flag to OFF when a phase of another inspection object W falls below the upper limit value TaU. When both of the phase change flag and the amplitude change flag are set to ON, the state change determination unit 62 of the control unit 6 determines that the state of the inspection object W is changed.

In addition, when the phase or the amplitude continuously exceeds or continuously falls below the threshold Tp or Ta for a predetermined period of time or longer, the state change determination unit 62 of the control unit 6 may set the phase change flag or the amplitude change flag to ON. As a result, while a sporadic and short-period variation in phase or amplitude caused by a dispersion or a disorder in transport posture allowed for each of the inspection objects W that are sequentially transported can be inhibited from being detected excessively, a change in phase or amplitude can be accurately detected.

In addition, when an average (for example, a moving average or a batch average) of a predetermined section (for example, a predetermined time or a predetermined number) in the chronological change in phase or amplitude exceeds or falls below the threshold Tp or Ta, the state change determination unit 62 of the control unit 6 may update the phase change flag or the amplitude change flag from OFF to ON or from ON to OFF. Even in this case, while inhibiting a sporadic and short-period large variation in phase or amplitude from being detected as an excessive change, a change in phase or amplitude can be accurately detected as a tendency.

In addition, an example of the state change determination process of the inspection object W based on the upper limit value and the lower limit value set with respect to the phase and the amplitude of the reception signal R immediately after the automatic setting process.

When the phase exceeds a phase upper limit value (threshold TpU) or falls below a phase lower limit value (threshold TpL), the state change determination unit 62 of the control unit 6 determines that a state change exceeding an allowable range occurs in the inspection object W. In addition, when the amplitude exceeds an amplitude upper limit value (threshold TaU) or falls below an amplitude lower limit value (threshold TpL), the state change determination unit 62 of the control unit 6 determines that a state change exceeding an allowable range occurs in the inspection object W. As a result, irrespective of the tendency where the amplitude or the phase changes depending on the state change of the inspection object W, the predetermined criterion used for the state change determination process can be set based on the upper limit value or the lower limit value with respect to the phase or the amplitude of the reception signal R immediately after the automatic setting process using a non-defective product of the inspection object W.

For example, when the automatic setting process is executed using a non-defective product of one type of the inspection object W, assuming that the phase of the reception signal R using this type of inspection object W is obtained as θa, the upper limit phase value TpU is set to θa + θd and the lower limit phase value TpL is set to θa - θd with respect to a predetermined standard used for the state change determination process. θd may be preset in the control unit 6 as an allowable value of a phase variation, or a plurality of values may be selectable depending on the type of the inspection object W. Likewise, regarding the amplitude, the upper limit amplitude value TaU and the lower limit amplitude value TaL can be set using an allowable value of an amplitude variation.

Next, as another example, the state change determination process using the Lissajous waveform will be described.

As illustrated in FIG. 5A, limit lines L (L1 to L3) are set as predetermined criteria on coordinates of the Lissajous waveform. The limit lines L1 to L3 are set not to intersect with the Lissajous waveform immediately after the automatic setting process that is executed using a non-defective product of the inspection object W. When a state change occurs, a change occurs in the Lissajous waveform such that the Lissajous waveform intersects with the limit lines L1 to L3 as illustrated in FIGS. 5B and 5C. At this time, the state change detection unit 62 of the control unit 6 sets a Lissajous waveform change flag to ON, and detects that a change occurs in the Lissajous waveform.

Here, the number of the limit lines L is not limited to three of exemplary L1 to L3. Specifically, the Lissajous waveform of the inspection object W using the automatic setting process and a Lissajous waveform of a sample of the inspection object W of a defective product where a state change is intentionally caused to occur may be compared to each other to set the limit lines L in a region between the Lissajous waveform of the non-defective product and the Lissajous waveform of the defective product. At this time, as long as a plurality of samples of non-defective products and defective products of the inspection object W having different states can be prepared, the limit lines L can be more accurately set in a state where a dispersion is grasped by causing Lissajous waveforms generated by the non-defective products and the defective products to overlap each other.

In the embodiment described above, the metal detector 1 determines whether or not metal foreign matter is contained in the inspection object W. Instead, the metal detector 1 may determine whether or not necessary metal is contained in the inspection object W.

In the above-described embodiment, when the influence value information including the phase, the amplitude, or the Lissajous waveform obtained by detecting the change in magnetic field caused by the passage of the inspection object W is changed to exceed the predetermined criterion, the state change determination unit 62 of the control unit 6 determines that the state of the inspection object W is changed, and notifies the determination. As a result, a state change that cannot be seen in appearance of the inspection object W can be grasped. Therefore, for example, before erroneously determining a non-defective product of the inspection object W as a product containing metal foreign matter, the state management of the inspection object W in a production line can be re-examined, or the automatic setting process of the metal detector 1 can be executed again. As a result, improvement of productivity of the inspection object W and a decrease in disposal loss can be facilitated.

In the above-described embodiment, when all of predetermined plural types of influence value information among the influence value information including the phase, the amplitude, or the Lissajous waveform obtained by detecting the change in magnetic field caused by the passage of the inspection object W exceed the predetermined criteria, respectively, the state change determination unit 62 of the control unit 6 determines that the state of the inspection object W is changed. As a result, when the influence value information of any one the phase, the amplitude, or the Lissajous waveform changes due to a dispersion in the size or the transport state of the inspection object W itself instead of a state change and exceeds the predetermined criterion, the state change determination unit 62 does not determine that the state of the inspection object W is changed. When the other influence value information is changed, the state change determination unit 62 determines that the state of the inspection object W is changed. Therefore, the state change of the inspection object W can be more accurately detected without being excessively detected.

In the above-described embodiment, the state change determination unit 62 of the control unit 6 stores the Lissajous waveform as the influence value information. As a result, the state change determination unit 62 can more accurately determine that the state of the inspection object W is changed based on the phase information and the amplitude information.

In the above-described embodiment, the state change determination unit 62 of the control unit 6 sets the limit lines L1 to L3 on the coordinates of the Lissajous waveform, and when the Lissajous waveform intersects with the limit lines L1 to L3, determines that the state of the inspection object W is changed. As a result, the predetermined criterion for determining the state change of the inspection object W can be simply set on the coordinate axis of the Lissajous waveform.

The present invention is not limited to the above-described embodiment, and can be modified, improved, and the like as appropriate. In addition, the material, shape, dimensions, number, disposition location, and the like of each component in the above-described embodiment are various as long as the present invention can be achieved, and are not limited.

In the above-described embodiment, the phase, the amplitude or the Lissajous waveform of the reception signal R is adopted as the influence value information, but the present invention is not limited thereto. The phase and the amplitude can be obtained from the detection signals DI and DQ, and the detection signals DI and DQ can be adopted as the influence value information. That is, as influence value information that is substantially equivalent from the viewpoint of including the phase information and the amplitude information, at least one of the phase, the amplitude, the Lissajous waveform, and the detection signals DI and DQ of the reception signal R may be adopted.

In the above-described embodiment, when the phase or the amplitude of the reception signal R is changed to exceed the predetermined criterion, the state change determination unit 62 of the control unit 6 detects that the state of the inspection object W is changed. However, the present invention is not limited to this example. For example, depending on characteristics of a production step of the inspection object W, in order to satisfactorily maintain the detection sensitivity of metal, the control unit 6 can track a phase of a reference signal output from the quadrature detection unit 51 in a predetermined range based on the detection signals DI and DQ output from the detection unit 5. In this case, when the phase change flag is switched to ON irrespective of whether or not a change in the phase of the reception signal R is detected based on the threshold Tp and a substantial change in amplitude is detected based on the threshold Ta to set the amplitude change flag to ON, the state change determination unit 62 determines that the state of the inspection object W is changed.

In the above-described embodiment, the metal detector 1 that generates an alternating magnetic field having a single frequency is described, but the present invention is not limited thereto. As illustrated in FIG. 6, depending on the type of metal foreign matter (for example, iron or non-ferrous metal), a metal detector 1B that generates an alternating magnetic field having plural types of frequencies (in the example illustrated in FIG. 6, two types of frequencies f1 and f2) may be used.

The metal detector 1B has a configuration including two signal generators 2 and 2 corresponding to the frequencies f1 and f2 of the alternating magnetic field, the magnetic field output unit 3 that generates the alternating magnetic field having both of the frequencies f1 and f2 on the transport path, the magnetic field reception unit 4 that outputs reception signals R1 and R2 having the frequencies f1 and f2 as the reception signal R, and two detection units 5 and 5 to which the reception signals R1 and R2 are input. In this case, when a state change is detected based on any one of the reception signals R1 and R2, for example, a phase, an amplitude, or a Lissajous waveform of the reception signal R1 having the frequency f1 and a phase, an amplitude, or a Lissajous waveform of the reception signal R2 having the frequency f2, the state change detection unit 62 of the control unit 6 detects the state change of the inspection object W.

### DESCRIPTION OF REFERENCE NUMERALS AND SIGNS

1: metal detector

3: magnetic field output unit

4: magnetic field reception unit

5: detection unit

6: control unit

7: storage unit

9: notification unit (display means, notification signal output means)

61: metal determination unit

62: state change determination unit

R: reception signal

W: inspection object

What is claimed is:

1. A metal detector comprising:
a magnetic field output unit configured to generate an alternating magnetic field in a transport path of an inspection object;
a magnetic field detection unit configured to detect a change in magnetic field caused by the inspection object passing through the alternating magnetic field to output a detection signal;
a metal determination unit configured to determine whether or not metal is contained in the inspection object based on the detection signal;
a storage unit configured to sequentially store, as influence value information, information including phase information and amplitude information that is obtained based on the detection signal when an accepted product passes through the alternating magnetic field, the accepted product being the inspection object that is determined not to contain metal by the metal determination unit;
a state change determination unit configured to determine whether or not a state of the inspection object is changed based on whether or not the influence value information exceeds a predetermined criterion; and
a notification unit configured to notify, when the state change determination unit determines that the state of the inspection object is changed, the determination.

2. The metal detector according to claim 1,
wherein the storage unit stores predetermined plural types of the influence value information, and
when all of the plural types of the influence value information exceed the predetermined criterion, the state change determination unit determines that the state of the inspection object is changed.

3. The metal detector according to claim 1,
wherein the storage unit stores a Lissajous waveform including the phase information and the amplitude information as the influence value information.

4. The metal detector according to claim 3,
wherein when limit lines are set as the predetermined criterion on coordinates of the Lissajous waveform and the Lissajous waveform and any one of the limit lines intersect with each other, the state change determination unit determines that the state of the inspection object is changed.
